(19) United States
(12) Patent Application Publication
(10) Pub. No.: US 2020/0408983 A1
(43) Pub. Date: Dec. 31, 2020

(54) FLEXIBLE DISPLAY DEVICE AND BACKLIGHT MODULE THEREOF

(71) Applicant: Wuhan China Star Optoelectronics Technology Co., Ltd., Wuhan, Hubei (CN)

(72) Inventor: Peng ZHANG, Wuhan, Hubei (CN)

(21) Appl. No.: 16/472,078

(22) PCT Filed: Nov. 26, 2018
(86) PCT No.: PCT/CN2018/117513

§ 371 Date: Jun. 20, 2019

(30) Foreign Application Priority Data
Oct. 9, 2018 (CN) 201821637478.5

(51) Int. Cl. F21V 8/00

(52) U.S. Cl. CPC G02B 6/0053; G02B 6/0055; G02B 6/0051

(57) ABSTRACT

A flexible display device and a backlight module thereof are provided. The backlight module includes a light guide plate and an optical film group including a single brightness enhancement film. The brightness enhancement film is a prism sheet, and a prism extending direction of the prism sheet is the same direction as a bending direction of the backlight module. The brightness enhancement film has a larger viewing angle of light in the orientation. Therefore, effect of increasing the brightness of the viewing angle can be achieved, and uniformity of the brightness of the viewing angle can be improved. Thereby, overall display effect of the flexible display device is improved.

### FIELD OF INVENTION

The present disclosure relates to a flexible display device and a backlight module thereof, and in particular, to a flexible display device and a backlight module thereof, which can be oriented to improve viewing angle brightness.

### BACKGROUND OF INVENTION

With development of flexible displays and curved display devices, under various conditions of fixed or unfixed curvatures, there are increasing viewing angles requirements for flexible and curved displays.

Referring to FIG. 1, a schematic view of a conventional backlight module of a flexible display device is illustrated. The backlight module 100 includes a light guide plate 110 for providing a backlight function required for a flexible display screen or a curved display screen (not shown). In addition, for convenience of explanation, FIG. 1 shows an XYZ coordinate system. Two sides of the light guide plate 110 are parallel to the X-axis and the Y-axis, respectively. An XY plane formed perpendicular to the X-axis and the Y-axis is the Z-axis direction.

As shown in FIG. 1, a reflective sheet 120 is disposed under the light guide plate 110. At least one light source 130 is disposed on a side of the light guide plate 110, and the light source 130 emits light from a side of the light guide plate 110. The light emitted by the light source 130 is turned to an upper side of the light guide plate 110 (the Y-axis direction) to emit light by a total reflection action inside the light guide plate 110 and the reflection effect of the reflection sheet 120.

In addition, an optical film group 140 is further disposed above the light guide plate 110. The optical film group 140 comprises a diffuser film 141 and two brightness enhancement films (BEFs). The two brightness enhancement films are a first brightness enhancement film 142 and a second brightness enhancement film 143, wherein the first brightness enhancement film 142 and the second brightness enhancement film 143 are respectively arranged with a plurality of elongated prisms 142a, 143a. These prisms have the effect of converge light upwards. Therefore, the light emitted upward from the light guide plate 110 first diffuses light through the diffuser film 141, then the light is converged by the first brightness enhancement film 142 and the second brightness enhancement film 143.

In general, because the prism is directional, the brightness enhancement effect of the brightness enhancement film in different directions is different. In order to resolve this difference, it is a common practice to make a prism direction of the second brightness enhancement film 143 and a prism direction of the first brightness enhancement film 142 perpendicular to each other. In order to balance the difference in the light of the above-mentioned brightness enhancement film in different directions.

However, the above method can balance the difference of light in different directions. The viewing angle of the backlight module 100 on the XY plane is reduced. When the backlight module 100 is applied to a flexible or curved display device, where the display device is bent, that is, at a position having a curvature, the viewing angle may be smaller, thereby reducing brightness of the light at this location, and affecting display effect of the display device.

As a result, it is necessary to provide an improved flexible display device and a backlight module thereof to solve the problems existing in the conventional technologies, as described above.

### SUMMARY OF THE INVENTION

An object of the present disclosure is to provide a flexible display device and a backlight module thereof, which includes a brightness enhancement film. The brightness enhancement film can provide better brightness of a viewing angle when the flexible display device is bent or forms a curved display.

To achieve the above objects, the present disclosure provides a backlight module of a flexible display device. The backlight module includes a light guide plate and an optical film group disposed above the light guide plate and including a single brightness enhancement film and a diffuser film, wherein the brightness enhancement film is a prism sheet and the diffuser film is disposed under the brightness enhancement film.

In one embodiment of the present disclosure, a reflective sheet is disposed under the light guide plate.

In one embodiment of the present disclosure, one side of the light guide plate is provided with at least one light source.

In one embodiment of the present disclosure, a prism extending direction of the prism sheet is the same direction as a bending direction of the backlight module.

To achieve the above objects, the present disclosure provides a backlight module of a flexible display device. The backlight module includes a light guide plate, and an optical film group disposed above the light guide plate and including a single brightness enhancement film.

In one embodiment of the present disclosure, a reflective sheet is disposed under the light guide plate.

In one embodiment of the present disclosure, one side of the light guide plate is provided with at least one light source.

In one embodiment of the present disclosure, the optical film group includes a diffuser film, wherein the diffuser film is disposed under the brightness enhancement film.

In one embodiment of the present disclosure, the brightness enhancement film is a prism sheet.

In one embodiment of the present disclosure, a prism extending direction of the prism sheet is the same direction as a bending direction of the backlight module.

To achieve the above objects, the present disclosure provides a flexible display device. The flexible display device includes a flexible display screen and a backlight module disposed under the flexible display screen, wherein the backlight module includes a light guide plate, and an optical film group disposed above the light guide plate and including a single brightness enhancement film.

In one embodiment of the present disclosure, a reflective sheet is disposed under the light guide plate, and one side of the light guide plate is provided with at least one light source.

In one embodiment of the present disclosure, the optical film group includes a diffuser film, wherein the diffuser film is disposed under the brightness enhancement film.

In one embodiment of the present disclosure, the brightness enhancement film is a prism sheet, and a prism extending direction of the prism sheet is the same direction as a bending direction of the backlight module.

In the present disclosure, compared to a conventional flexible display device, the single brightness enhancement film of the present disclosure has a large viewing angle of light in orientation. Therefore, the effect of increasing the brightness of the viewing angle can be achieved, and the uniformity of the brightness of the viewing angle can be improved. Thereby, the overall display effect of the flexible display device is improved.

### DESCRIPTION OF DRAWINGS

FIG. 1 is a schematic view of a conventional backlight module of a flexible display device.

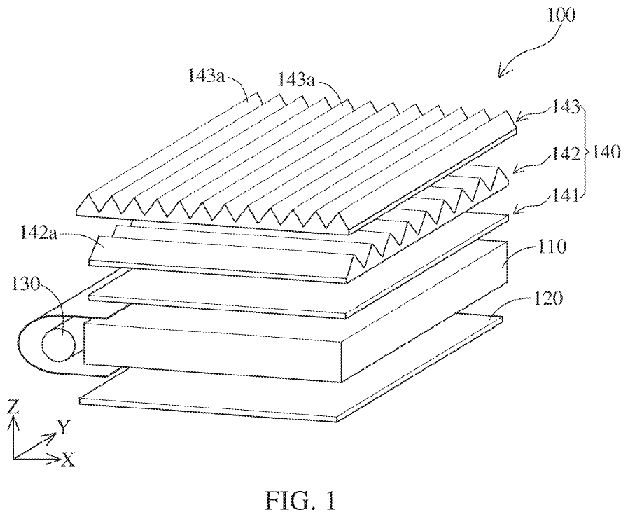

FIG. 2 is a schematic view of a backlight module of a flexible display device according to an embodiment of the present disclosure.

FIG. 3 is a side view of the backlight module (in a YZ plane) according to an embodiment of the present disclosure.

FIG. 4 is a side view of the backlight module (in an XZ plane) according to an embodiment of the present disclosure.

FIG. 5 is a side view of the backlight module (in an XY plane) according to an embodiment of the present disclosure.

FIG. 6 is a side view of a flexible display device (in an XZ plane) according to an embodiment of the present disclosure.

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

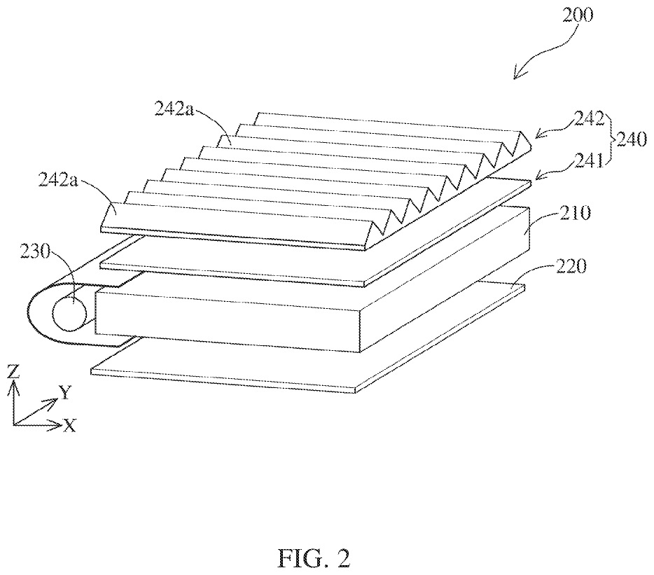

Referring to FIG. 2, a schematic view of a backlight module of a flexible display device according to an embodiment of the present disclosure is illustrated. The backlight module 200 of the flexible display device of the present disclosure includes a light guide plate 210, and the light guide plate 210 is configured to provide a backlight function that a flexible display or a curved display requires. Moreover, for the convenience of explanation, it is shown an XYZ coordinate system in FIG. 2, and the two sides of the light guide plate 210 are parallel to the X-axis and the Y-axis, respectively. In addition, the XY plane formed perpendicular to the X-axis and the Y-axis is the Z-axis direction.

Referring to FIG. 2, a reflective sheet 220 is disposed under the light guide plate 210. One side of the light guide plate 210 is provided with at least one light source 230. The at least one light source 230 emits light from the side of the light guide plate 210. Through the total reflection inside the light guide plate 210 and the reflection of the reflective sheet 220, the light emitted by the at least one light source 230 is directed to the upper side of the light guide plate 210 (the direction in the Y-axis direction) to emit light.

In addition, an optical film group 240 is disposed above the light guide plate 240, and the optical film group 240 includes a diffuser film 241 and a single brightness enhancement film (BEF) 242. A plurality of elongated prism sheets 242a are arranged on the brightness enhancement film 242, and the prism sheets 242a are arranged in the Y-axis direction and extend in the X-axis direction. The prism sheets 242a have an effect of converging light upwards. Therefore, the light emitted from the light guide plate 210 can be diffused by the diffuser film 241 first, and then the light is converged by the brightness enhancement film 242. However, in general, due to the directivity of the prism sheets, the brightness enhancement effect of the brightness enhancement film in different directions is different.

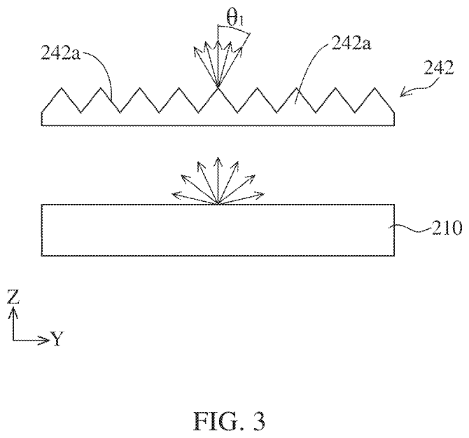

Referring to FIG. 3, a side view of the backlight module (in a YZ plane) according to an embodiment of the present disclosure is illustrated. In particular, in order to make the drawing more concise, the diffuser film 241 is omitted in the drawing, and the light source below the brightness enhancement film 242 is directly indicated by the light guide plate 210. As shown in FIG. 3, since the prism sheets 242a located on the brightness enhancement film 242 are arranged along the Y-axis direction. Therefore, it has a better ray convergence effect on the YZ plane, but also makes the viewing angle smaller, for example, the half angle of view 81 of the light is 35 degrees.

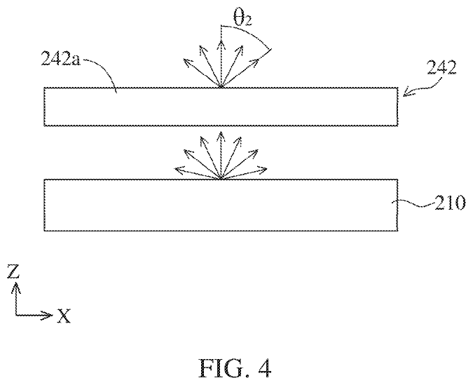

Referring to FIG. 4, a side view of the backlight module (in an XZ plane) according to an embodiment of the present disclosure is illustrated. In particular, in order to make the drawing more concise, the diffuser film 241 is omitted in the drawing, and the light source below the brightness enhancement film 242 is directly indicated by the light guide plate 210. As shown in FIG. 4, because the prism sheets 242a located on the brightness enhancement film 242 are arranged along the X-axis direction, the ray convergence effect on the XZ plane is poor, but the viewing angle is also large, for example, the half angle of view 82 of the light is 52 degrees.

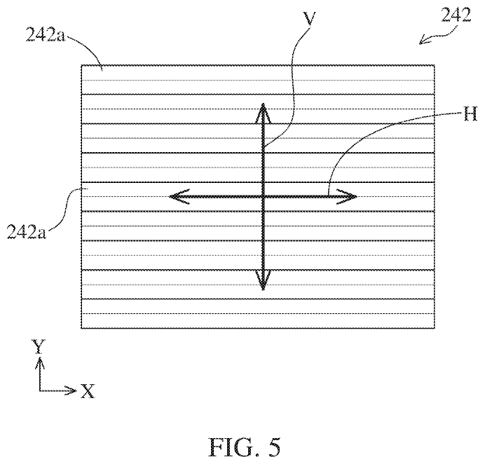

Referring to FIG. 5, a side view of the backlight module (in an XY plane) according to an embodiment of the present disclosure is illustrated. When the brightness enhancement film 242 is used, there is a larger viewing angle (such as a half angle of view of 52 degrees) in a horizontal sight direction H (parallel X axis) of a viewer. However, in the viewer's vertical sight direction V (parallel to the Y axis), there is a smaller viewing angle (such as a half angle of view of 35 degrees).

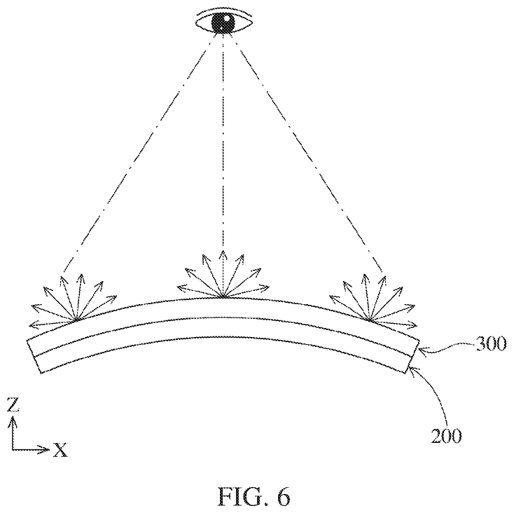

Referring to FIG. 6, a side view of a flexible display device (in an XZ plane) according to an embodiment of the present disclosure is illustrated. The backlight module 200 is disposed under a flexible display screen 300 to form a flexible display device. It can be seen from the description in FIG. 3 to FIG. 5, the brightness enhancement film 242 has a larger viewing angle of light in the XZ plane, that is, a larger viewing angle of light in the horizontal sight direction H (parallel to the X axis) of the viewer.

Referring to FIG. 6, when the flexible display device is bent or forms a curved display, a prism extending direction of the prism sheet (refer to the X-axis direction in FIG. 5) and a bending direction of the flexible display device, that is, a bending direction of the backlight module are the same direction (refer to the X-axis direction in FIG. 6). A viewer located at a distance in front of the curved portion of the display, a larger viewing angle (such as a half angle of view of 52 degrees) is obtained in orientation (in the horizontal sight direction). Therefore, it is possible to achieve an effect of increasing the brightness of the viewing angle, and to improve the uniformity of the brightness of the viewing angle. Thereby, the overall display effect of the flexible display device can be improved.

The present disclosure has been described with preferred embodiments thereof and it is understood that many changes and modifications to the described embodiments can be carried out without departing from the scope and the spirit of the disclosure that is intended to be limited only by the appended claims.

What is claimed is:

1. A backlight module of a flexible display device, comprising:
a light guide plate; and
an optical film group disposed above the light guide plate and including a single brightness enhancement film and a diffuser film, wherein the brightness enhancement film is a prism sheet and the diffuser film is disposed under the brightness enhancement film.

2. The backlight module according to claim 1, wherein a reflective sheet is disposed under the light guide plate.

3. The backlight module according to claim 1, wherein one side of the light guide plate is provided with at least one light source.

4. The backlight module according to claim 1, wherein a prism extending direction of the prism sheet is the same direction as a bending direction of the backlight module.

5. A backlight module of a flexible display device, comprising:
a light guide plate; and
an optical film group disposed above the light guide plate and including a single brightness enhancement film.

6. The backlight module according to claim 5, wherein a reflective sheet is disposed under the light guide plate.

7. The backlight module according to claim 5, wherein one side of the light guide plate is provided with at least one light source.

8. The backlight module according to claim 5, wherein the optical film group includes a diffuser film, wherein the diffuser film is disposed under the brightness enhancement film.

9. The backlight module according to claim 5, wherein the brightness enhancement film is a prism sheet.

10. The backlight module according to claim 9, wherein a prism extending direction of the prism sheet is the same direction as a bending direction of the backlight module.

11. A flexible display device, comprising a flexible display screen and a backlight module disposed under the flexible display screen, wherein the backlight module comprises:
a light guide plate; and
an optical film group disposed above the light guide plate and including a single brightness enhancement film.

12. The flexible display device according to claim 11, wherein a reflective sheet is disposed under the light guide plate, and one side of the light guide plate is provided with at least one light source.

13. The flexible display device according to claim 11, wherein the optical film group includes a diffuser film, wherein the diffuser film is disposed under the brightness enhancement film.

14. The flexible display device according to claim 11, wherein the brightness enhancement film is a prism sheet, and a prism extending direction of the prism sheet is the same direction as a bending direction of the backlight module.
